(19) United States
(12) Patent Application Publication
(10) Pub. No.: US 2026/0255294 A1
(43) Pub. Date: Aug. 27, 2026

(54) COMMUNICATION, MANAGEMENT AND DISCOVERY METHODS, AND DEVICES CONFIGURED TO CARRY OUT SAID METHODS

(71) Applicant: Orange, Issy-les-Moulineaux (FR)

(72) Inventors: Charles Hartmann, Chatillon (FR); Antoine Mouquet, Chatillon (FR)

(21) Appl. No.: 18/876,886

(22) PCT Filed: Jun. 22, 2023
(86) PCT No.: PCT/EP2023/067008

§ 371 Date: Dec. 19, 2024

(30) Foreign Application Priority Data
Jun. 27, 2022 (FR) FR2206372

(51) Int. Cl. H04W 60/00

(52) U.S. Cl. CPC H04W 60/00

(57) ABSTRACT

A method for communicating with a control device in a cellular communication network is described, the control device being configured to manage application entities in the network offering services in the network and maintain a profile of these application entities. The method includes registering a profile in control device, the profile comprising information representative of current deployment conditions of at least one network cell managed by a base station of the network.

### PRIOR ART

The invention belongs to the general field of telecommunications.

It more specifically relates to the delivery of information for improving certain functionalities implemented by entities of a cellular communication network. The invention has a preferable but non-limiting application within the context of a cellular communication system or network based on a 5G core network (or 5GC) as defined by the 3GPP standard. Within this context, it notably improves the functionalities implemented by the access and mobility management entity, which is also referred to as AMF (“Access and Mobility management Function”).

As notably described in the 3GPP document TS 23.501 entitled, “Technical Specification Group Services and System Aspects; System architecture for the 5G System (5GS); Stage 2 (Release 17)”, V17.4.0, March 2022, in a 5G core network the AMF entity provides various functionalities, such as, for example, managing the registration of user equipments (or UE), their connection to the network and their reachability, management of the mobility of the UEs, authentication and authorization of network access, etc.

When a UE registers with the network, the AMF allocates it a set, called “TAI-list”, of identifiers of areas, called locations or TA (“Tracking Area”), with each TA comprising one or more cells of the cellular network. Such a TAI-list (with TAI meaning “TA Identity”) defines the Registration Area, or RA, of the UE. The RA of the UE, which therefore can include one or more cells of the cellular network, allows this UE to be located, notably when it is in idle mode. Indeed, when the network receives a data packet intended for a UE in idle mode, it sends one or more paging messages in the area defined by its RA. Although it is in idle mode, the UE still listens for paging messages, and when it detects a paging message relevant thereto, it switches to connected mode and can thus receive its intended data packet.

Moreover, when a UE enters a cell, it compares the TAI broadcast by the base station managing this cell with the TAIs present in its RA. If the TAI broadcast by the base station is not contained in the RA allocated thereto, the UE initiates a registration procedure with the network to notify it of its new location, in other words, the TA it has just entered. The network then allocates a new RA to the UE (i.e., a new TAI-list) containing the TA indicated by the UE.

These procedures allow a UE to be easily located, all while limiting the signaling exchanged over the network.

The 3GPP standard does not, strictly speaking, provide an optimal way of allocating an RA (in other words, a TAI-list) to a UE. The AMF can use miscellaneous information provided by the base stations, such as, for example, their TAIS, the TAs to which they belong or the network slices that they support. However, as emphasized in document S2-2104656 entitled, “Some network slicing topics proposals for rel-18”, presented by Nokia and Nokia Shanghai Bell at the 3GPP SA WG2 #145E meeting in May 2021, the 3GPP standard does not currently define means allowing the AMF to have information that notably relates to the topology of the base stations or their geographic coverage. However, in order to allocate a relevant RA to a UE taking into account its behavior, notably in terms of mobility (speed, direction of movement, etc.), knowing which TAs support a given network slice does not suffice. It is also important to know the adjacency relations between the cells: for example, TAs can be adjacent in geographical terms, but not necessarily from a logical perspective (for example, the presence of a physical obstacle between TAs preventing a UE from passing from one to the other).

Document S2-2104656 proposes studying this theme within the context of Release 18, yet without providing a solution at this stage.

### DISCLOSURE OF THE INVENTION

The invention addresses this requirement by proposing a method for communicating with a control device of a cellular communication network, configured to manage application entities of the network offering services in the network and to maintain a profile of these application entities. This method comprises a step of registering a profile with the control device comprising information representing current deployment conditions of at least one network cell managed by a base station of the network.

Correspondingly, the invention also proposes an entity of a cellular communication network comprising a registration module configured to register a profile with a network control device, managing application entities of the network offering services in the network and maintaining a profile of these application entities, with said profile registered by the registration module comprising information representing current deployment conditions of at least one network cell managed by a base station of the network.

Within the meaning of the invention, an application entity is an entity configured to implement one or more determined processing logics in the network, such as an entity offering and/or consuming one or more services of the network. Such an entity can be located in the access network or in the network core (also called “core network”), and can thus implement, by means of the services that it offers, one or more functionalities of the network, such as, for example, the functionalities of a Network Function (NF), such as an AMF function or an SMF (“Session Management Function”) function, the functionalities of a base station, etc. It can be a physical or virtual entity, such as, for example, a virtual instance of a network function or a hardware device hosting such a network function or network function instance.

In the example of a 5G network defined by the 3GPP standard, a control device managing such application entities and maintaining their profiles is typically a network function of the Network Repository Function (NRF) type, which, in the current prior art, manages the profiles of the network functions (or network function instances) of the core network. Each profile associated with an application entity and stored by the NRF function comprises a plurality of attributes likely to be used by other entities of the network wishing to consume the services of the application entity in question, and notably characterizing its operational state (for example, its availability, its load, etc.), its features (for example, its identity, the type of NF function that it implements, how it can be joined, etc.), the services that it offers, the resources that it manages, etc.

The invention therefore proposes, in order to allow the application entities of the network (and notably of the core network) to easily access information representing the current deployment conditions of the cells of the network (such as, for example, the aforementioned adjacency relations of the cells), registering this information on a network control device (such as an NRF function of a 5G network) already managing profiles of application entities of the network. In other words, the profiles already stored by the control device and relating to the application entities of the network are supplemented by other profiles containing information relating to the actual deployment of the cells of the network. Various levels of granularity can be contemplated for these other profiles, namely, a profile for each network cell or a profile for each base station managing at least one network cell.

Advantageously, storing information representing current deployment conditions of the network cells in a profile maintained by such a control device facilitates the management and updating, if applicable, of this information, as well as its access by other network entities that can use the existing procedures (standardized or non-standardized) to access the profiles of the application entities of the network in order to access these other profiles. The invention thus can be implemented using signaling interfaces of the network that are already present (control plane of the network), such as, for example, interfaces standardized by the 3GPP standard (for example, an Application Programming Interface or API), notably when the control device hosts an NRF network function. It does not require the development of an additional management layer, which would make the system more complex and would limit the dynamics of the exchanges of information, for example, in the event of a modification to the deployment conditions (for example, linked to an automatic reconfiguration of a base station and to the modification of the neighboring information that can be derived therefrom).

By virtue of the information that is made available by the invention, the quality of the decisions made in the network, and notably in the core network, can be improved. Information representing current deployment conditions of a cell is understood to mean information reflecting the actual conditions in which the cell is deployed at the considered instant. Various types of information are involved. For example, at least one of said items of information representing current deployment conditions relates to:
an arrangement of the cell in a network architecture (for example, coverage, radio proximity);
a geographical enivornment of the cell;
a type of deployment of the cell;
a configuration of at least one antenna of the cell;
at least one infrastructure covered by the cell (for example, road, railway, building, etc.); and/or
a state of the cell (for example, load of the cell, load on each network slice, number of active users, uplink (UL) throughput or downlink (DL) throughput, congestion indicators, alarm state, security state, etc.).

This information is dynamic and is likely to evolve over time, typically due to a reconfiguration of the base stations, the appearance of new infrastructures, the suppression of certain cells (for example, small cells provided for capacitive reasons, during periods when the network is hardly used, like at night, in order to reduce the energy consumption of the network), etc. Such information is, with the exception of some information relating to the state of the cell, not currently known to the base stations: the base station is unaware of the actual deployment context of the cells that it manages, it only has radio parameters that it uses to manage the quality of the radio links, to maintain the communications using measurements that it carries out and/or that are fed back by the UEs and/or to broadcast cell selection/reselection parameters to the UEs. This type of information is not actually currently used by the base stations in the processing operations assigned to them. With respect to the information relating to the state of the cell and/or of the base station, this is not shared with other entities whether this is the UEs, other base stations of the cellular network or even the network functions of the core network.

Awareness of the actual deployment of the network cells can be used to improve the efficiency of the procedures implemented in the network, whether in the core network or in the access network, and incidentally the resulting quality of service. For example, the mobility predictions of a UE carried out by an NWDAF (“NetWork Data Analytics Function”) network function in a 5G network can be facilitated and their precision can be improved if it is understood that the UE moves on a main road (for example, the NWDAF function can assign a higher probability to the positions of the UE found on this main road). According to another example, the congestion information of a cell or the average throughput achieved for UL and/or for DL can influence the quality of service predictions, and the decisions made based on these predictions. According to yet another example, when contemplating a context in which a base station can poll the control device in order to access the information relating to the current deployment conditions of the network cells, such information can be useful thereto when deciding upon a transfer (or handover) between cells and on the procedures for this transfer (typically from the target base station to which this transfer is initiated). Of course, these examples of the use of the invention are provided solely by way of an illustration.

It should be noted that other information relating to the cell, in addition to the information relating to the current deployment conditions of the cell, can be registered in the profile with the control device, such as, for example, static configuration information of the cell, such as:
an identity of the cell; and/or
a frequency band allocated to the cell; and/or
at least one radio access technology associated with the cell;
etc.;
   or other information more related to the operational functioning of the network, such as, for example, a cell belonging to a TA.

Of course, this list is not exhaustive, and it is possible to contemplate enriching the profile of the cell or of the base station with yet more information, such as, for example, with information relating to the base station that is already known and shared by the base station in the prior art, such as its identity, the list of TAs and/or slices that it supports, or information relating to a state of the base station (for example, load level, congestion level), etc.

As mentioned above, the invention is preferably applicable within the context of a 5G network. However, it can be used in other contexts.

Indeed, some participants in the telecommunications field anticipate, for the 6th generation of mobile networks (also more commonly called 6G), the suppression of the borders between the one or more access networks and the core network. With this in mind, the network architectures based on control plane signaling interfaces can have significant advantages, granting access to the internal contexts specific to the virtualized equipment/functions of the network. The invention therefore can be easily applied in such a context as well.

In a particular embodiment, the information relating to the deployment conditions of the cells is directly registered with the control device by the base stations managing these cells. The invention therefore also relates to a base station of a cellular communication network hosting an entity according to the invention, with said information relating to at least one cell managed by said base station.

In this embodiment, all or some of the information relating to the current deployment conditions of the network cells can be configured on the base stations by the network operator (for example, in the form of unstructured metadata (for example, XML, JSON, YAML formats, etc.) in a data repository that is standardized or is specific to the network operator) or can be acquired or determined by the base stations themselves.

Thus, the communication method, when it is implemented by the base station, can comprise a step of evaluating at least a portion of said information before registering it with the control device.

By way of an illustration, it is possible to contemplate the base station evaluating the geographical range of the coverage area of a cell based on the geographical positions of the UEs served thereby, with these positions being able to be provided by satellite positioning modules (for example, GPS (“Global Positioning System”), GNSS (“Global Navigation Satellite Systems”) installed on the UEs or deduced by the base station based on information it has available concerning these UEs, such as their speed or an Observed Time Difference of Arrival (OTDOA).

As a variant, the communication method, when it is implemented by the base station, can comprise a step of acquiring, from a network-adapted radio planning system, at least a portion of said information before registering it with the control device.

A radio planning system can typically provide information concerning the type of deployment contemplated for the cell: in a dense, suburban or rural area, in the line-of-sight (or LOS) or non-line-of-sight (or NLOS), event-driven or temporary deployment, configuration of the cell (for example, macro-, micro- or pico-cell), configuration of the antennas of the cell (for example, Distributed Antenna System or DAS), etc. It can also provide information concerning the infrastructures covered by the cell, for example, if it is deployed to cover a main road, a waterway, a port, a railway track, a station, and, if applicable, to identify the infrastructures in question.

In a particular embodiment, the information relating to the deployment conditions of the cells is registered with the control device by means of a network application entity that acquires this information from the base stations. Such an application entity is, for example, an access management device of the cellular network, such as an AMF network function within the context of a 5G network. Therefore, a further aim of the invention is an access management device of a cellular communication network hosting an entity according to the invention.

In a particular embodiment, in which the communication method is implemented by an access management device of the cellular network, the communication method can comprise a step of acquiring at least a portion of said information from the base station when associating said base station with said access management device.

Therefore, a further aim of the invention is a base station of a cellular communication network comprising a transmission module configured to transmit a profile to an access management device of the cellular network comprising information representing current deployment conditions of at least one network cell managed by the base station.

This embodiment has a preferable, but by no means limiting, application when the base station does not support one or more protocols used on the signaling interfaces with the control device; it therefore proposes passing through an intermediate entity of the core network capable of directly communicating with the control device and notably of registering a profile with this control device.

Thus, in the example of a 5G network and of a control device of the NRF function type, this embodiment can be advantageous, notably when the base station does not support the HTTP2 protocol that allows the services of the NRF function to be consumed. The invention then proposes using the procedure for associating the base station with the access management device (AMF, in the example of the 5G network) to send the current deployment information of the cells that it manages to the access management device, then instructs said device to register this information with the network control device in a profile, in a similar or identical manner to the manner by which it registers its own profile with this control device.

Of course, it is possible to contemplate the base station transmitting the current deployment condition information of the cells that it manages at another time, either in a dedicated message exchanged with the access management device or during another exchange provided by the standard with this device.

As mentioned above, the invention uses the registration of information concerning the current deployment conditions of network cells in profiles maintained by a network control device. It also uses the provision of this information concerning the current deployment conditions by the control device, and the exploitation of this information.

Thus, according to another aspect, the invention relates to a method for managing a cellular communication network using a control device, configured to manage application entities of the network offering services in the network and to maintain a profile of these application entities, said method comprising:
a step of registering a profile provided by an entity of the cellular network and comprising information representing current deployment conditions of at least one cell of the cellular network managed by a base station of the network;
in response to a discovery request received from a device, called requesting device, of the network, a step of transmitting all or some of said profile to said requesting device.

Correspondingly, a further aim of the invention is a control device of a cellular communication network configured to manage application entities of the network offering services in the network and to maintain a profile of these application entities, said control device comprising:
a registration module, configured to register a profile delivered by an entity of the cellular network, said profile comprising information representing current deployment conditions of at least one cell of the cellular network managed by a base station of the network; and
a response module, configured to transmit, in response to a discovery request received from a device of the network, called requesting device, all or some of said profile to said requesting device.

As mentioned above, the profile can be delivered to the control device by the base station or by an intermediate network entity, such as an access management device of the cellular network (for example, AMF function).

The management method and the control device benefit from the same aforementioned advantages as the communication method and the entity according to the invention.

In a particular embodiment, the management method comprises:
a step of updating at least one item of said information in said profile; and
a step of notifying said requesting device of said at least one updated item of information.

This notification can be made following a request from the requesting device, or can be made spontaneously, for example, when the requesting device has subscribed, with the control device, to a service for indicating any changes affecting said profile.

This embodiment keeps the application entities of the network that use the information concerning the deployment conditions of the cells informed of any change in these conditions.

According to yet another aspect, the invention relates to a discovery method using a device, called requesting device, of a cellular communication network, said method comprising:
a step of sending a discovery request to a network control device configured to manage application entities of the network offering services in the network and to maintain a profile of these application entities, with said discovery request relating to at least one cell managed by a base station of the cellular network;
a step of receiving a response to said discovery request comprising information representing current deployment conditions of said at least one cell stored in a profile maintained by the control device; and
a step of using all or some of said received information when delivering a functionality implemented by the requesting device in the network.

Correspondingly, a further aim of the invention is a device, called requesting device, of a cellular communication network comprising:
a sending module configured to send a discovery request to a network control device managing network application entities offering services in the network and maintaining a profile of these application entities, said discovery request relating to at least one cell managed by a base station of the cellular network;
a receiving module, configured to receive a response to said discovery request comprising information representing current deployment conditions of said at least one cell stored in a profile maintained by the control device; and
a utilization module, configured to use all or some of said received information when delivering a functionality implemented by the requesting device in the network.

The discovery method and the requesting device benefit from the same aforementioned advantages as the communication method, the management method, the entity and the control device according to the invention. It should be noted that it can be a device of the core network, such as, for example, a device hosting a network function (or a network function instance), or a device of the access network, such as a base station, for example.

In a particular embodiment, the communication, management and discovery methods are implemented by a computer.

A further aim of the invention is a computer program on a storage medium, with this program being able to be implemented in a computer or more generally in an entity according to the invention and comprising instructions adapted for implementing a communication method as described above.

A further aim of the invention is a computer program on a storage medium, with this program being able to be implemented in a computer or more generally in a control device according to the invention and comprising instructions adapted for implementing a management method as described above.

A further aim of the invention is a computer program on a storage medium, with this program being able to be implemented in a computer or more generally in a requesting device according to the invention and comprising instructions adapted for implementing a discovery method as described above.

Each of these programs can use any programming language, and can be in the form of source code, object code, or of intermediate code between source code and object code, such as in a partially compiled format, or in any other desirable format.

A further aim of the invention is an information medium or a computer-readable storage medium, and comprising instructions of a computer program as mentioned above.

The information or storage medium can be any entity or device capable of storing the programs. For example, the medium can comprise a storage means, such as a ROM, for example, a CD-ROM or a microelectronic circuit ROM, or even a magnetic storage means, for example, a hard disk, or a flash memory.

Moreover, the information or storage medium can be a transmissible medium such as an electrical or optical signal, which can be routed via an electrical or optical cable, via a radio link, via a wireless optical link or via other means.

The program according to the invention particularly can be downloaded over a network of the Internet type.

Alternatively, the information or storage medium can be an integrated circuit, in which a program is incorporated, with the circuit being adapted to execute or to be used to execute the communication, management and discovery methods according to the invention.

According to another aspect, the invention also relates to a system in a cellular communication network comprising:
at least one base station managing at least one network cell;
at least one network entity according to the invention;
a control device according to the invention; and
at least one requesting device according to the invention.

In a particular embodiment, the network entity is hosted by the base station.

In another embodiment, the network entity is hosted by an access management device of the network and the base station is a base station according to the invention.

It is also possible to contemplate, in other embodiments, that the communication, management and discovery methods, and the entities, the control device, the requesting device and the system according to the invention in combination have all or some of the aforementioned features.

### BRIEF DESCRIPTION OF THE DRAWINGS

Further features and advantages of the present invention will become apparent from the following description, with reference to the appended drawings, which illustrate an exemplary embodiment that is by no means limiting. In the figures:

FIG. 1 shows, in its environment, a system in a network according to the invention, in a first embodiment;

FIG. 2 schematically shows the hardware architecture of a computer capable of hosting an entity, a control device and a requesting device according to the invention;

FIG. 3 shows the functional modules of an entity, of a base station, of a control device and of a requesting device according to the invention, in the first embodiment;

FIG. 4 illustrates, in a first example of an application, the steps of the communication, management and discovery methods implemented by the system of FIG. 1 in the first embodiment;

FIG. 5 illustrates, in a second example of an application, the steps of the communication, management and discovery methods implemented by the system of FIG. 1 in the first embodiment;

FIG. 6 shows, in its environment, a system in a network according to the invention, in a second embodiment;

FIG. 7 shows the functional modules of an entity, of an access management device, of a control device and of a requesting device according to the invention, in the second embodiment;

FIG. 8 illustrates the steps of the communication, management and discovery methods implemented by the system of FIG. 6 in the second embodiment.

### DESCRIPTION OF THE INVENTION

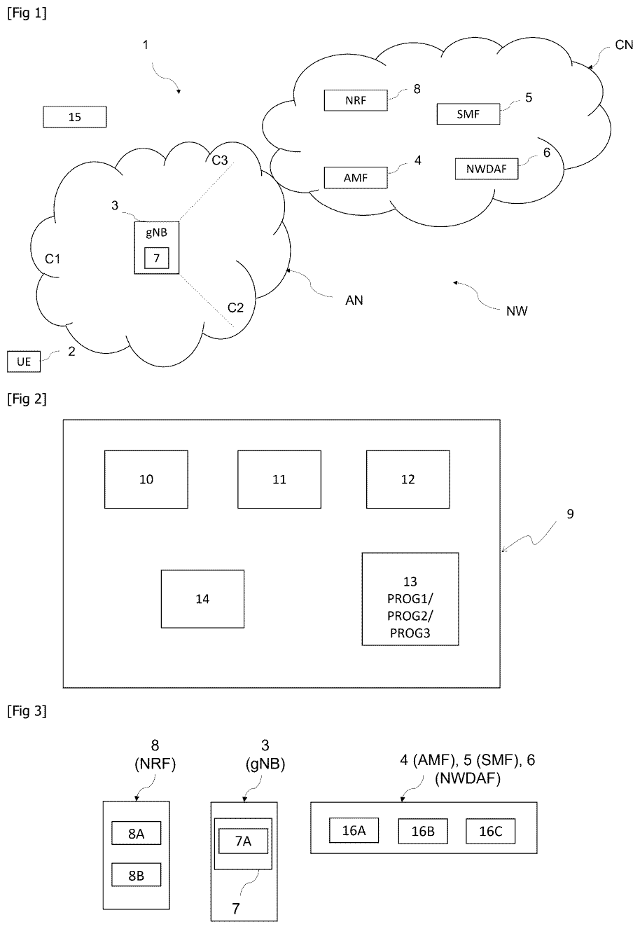

FIG. 1 shows a system 1 in a cellular communication network NW, according to the invention, in a first embodiment of the invention. The network NW in this case is a 5G network as defined by the 3GPP standard, managed by an operator OP, with the network NW comprising at least one access network AN and a core network CN.

In a manner known per se, the core network CN uses a plurality of network functions or NF functions (application entities of the network within the meaning of the invention) offering various services and implementing various functionalities in the core network CN, such as, for example, an AMF function managing network access and the mobility of the UEs linked to the network, an SMF function managing the sessions established in the network, an NRF function maintaining the profiles of the NF functions of the network, an NWDAF function of the network for collecting data and predicting, etc. One or more instances of each of the NF functions of the core network CN can be deployed to ensure the operational functioning thereof.

In order to access the services offered by the network NW, a user equipment, or UE 2, connects to the core network CN via the access network AN, and more specifically a gNB base station 3 of this access network. The nature of the UE 2 is by no means limiting: it can be a smartphone, a laptop computer, a tablet, an object, a machine or a connected vehicle, etc.

In a manner known per se, each gNB base station (and in particular the base station 3) is configured to manage one or more cells of the network NW. The term “cell” is understood herein to mean a “unitary” geographical area of the network NW, to which geographical area a cell identifier (or “NR Cell Identity”) uniquely designating said area and transmission parameters (for example, a frequency band) are associated. It should be noted that the same transmission parameters can be simultaneously used by several cells of the network duly distributed in order to limit any interference. In the example of FIG. 1, it is assumed that the base station 3 is a tri-sectorial gNB and thus manages three cells of the network C1, C2 and C3 respectively corresponding to the three sectors covered by the base station 3.

There is no limit associated with the type of base stations considered for the access network AN. Fixed and/or mobile base stations (for example, on board a vehicle, in a drone or more generally in any system capable of moving) can be contemplated.

As mentioned above, the 5G context described above is not limiting per se; indeed, the invention can be applied to other networks, such as, for example, to a 6G network, to a proprietary network, etc.

According to the invention, the system 1 comprises:
at least one gNB base station managing at least one cell of the network NW, namely, the base station 3 managing the cells C1, C2 and C3 of the network NW;
at least one requesting device, according to the invention, namely, in the first embodiment described herein, the AMF network function instance 4, the SMF network function instance 5 and the NWDAF network function instance 6. Of course, these examples are provided solely by way of an illustration, and other entities of the network NW, in particular other network functions or network function instances of the core network CN or base stations of the access network AN can be requesting devices within the meaning of the invention;
at least one entity 7 of the network NW according to the invention. In the first embodiment illustrated in FIG. 1, the entity 7 is hosted in the base station 3. However, as described hereafter with reference to a second embodiment of the invention, the entity 7 can be hosted in other entities of the network NW, and notably in a device hosting a network function of the core network CN, such as, for example, in the device hosting the AMF network function instance 4;
a control device 8 of the network NW, according to the invention, managing various application entities of the network and maintaining a profile of each of them. This control device 8 is, within the context of the 5G network contemplated herein, a device hosting an NRF network function (also referred to as NRF device 8 hereafter), which, in a manner known per se, manages the NF function instances of the core network CN and maintains a profile of each of these instances, generally denoted NFPROF herein. Each profile NFPROF associated with an NF function instance and stored by the NRF function comprises a plurality of attributes likely to be used by other entities of the core network CN wishing to consume the services of the instance in question, and notably characterizing its operational state (for example, its availability, its load, etc.), its features (for example, its identity, the type of NF function that it implements, how it can be joined, etc.), the services that it offers, the resources that it manages, etc. According to the invention, and as described in further detail hereafter, the NRF device 8 also maintains a profile, denoted gNBPROF, for each of the gNB base stations of the network NW (or at least some of them), or, in an alternative embodiment, a profile, denoted CellPROF, for each of the cells of the network NW managed by all or some of the gNB base stations of the network. The choice of any of the options (one profile per base station or one profile per cell) is at the discretion of the operator OP of the network NW. Throughout the remainder of the description, the NRF device 8 maintains one profile gNBPROF per gNB base station of the access network AN.

It should be noted that the system 1 can comprise a plurality of control devices 8 according to the invention, with each control device 8 being configured to manage at least some of the network functions of the core network CN and to maintain the profiles of at least some of the base stations of the access network AN or the profiles of the cells managed by said at least some of the base stations.

In the first embodiment described herein, the NRF device 8, the entity 7 (and the base station 3 hosting it) and the requesting devices 4, 5 and 6 have the hardware architecture of a computer 9, as shown in FIG. 2, or are hosted by the computer 9.

The computer 9 notably comprises a processor 10, a random-access memory 11, a read-only memory 12, a non-volatile memory 13, and communication means 14 notably allowing the NRF device 8, the entity 7 hosted by the base station 3 and the instances 4, 5 and 6 of the system 1 to communicate with one another, as well as with devices of the core network CN and/or more generally of the cellular network NW, or with entities outside the network, such as, for example, with a radio scheduling system 15 adapted to the network NW (for example, that used by the operator OP of the network NW to deploy its network).

The non-volatile memory 13 of the computer 9 forms a storage medium according to the invention that can be read by the processor 10 and stores one or more computer programs according to the invention.

More specifically, the non-volatile memory 13 of the computer 9 comprises, when it is the NRF device 8 or it hosts the NRF device 8, a recording of a computer program PROG1, comprising instructions defining the main steps of a management method according to the invention.

This program PROG1 defines the functional modules of a control device according to the invention (such as the NRF device 8 in the first embodiment described herein) that use or control the aforementioned hardware elements 10 to 14 of the computer 9. These modules notably comprise, as illustrated in FIG. 3:
a profile registration module 8A, configured to register, for example, in the non-volatile memory 13, the profiles NFPROF of the application entities of the core network CN, and more specifically network function instances of the core network CN (for example, AMF function instances 4, SMF function instances 5 and NWDAF function instances 6), but also, according to the invention, to register the profiles gNBPROF of the base stations of the cellular network NW (and more specifically of the access network AN of the cellular network NW), with each profile gNBPROF associated with a gNB base station of the network NW comprising, for each cell managed by the base station in question, information representing the current deployment conditions of this cell. As mentioned above, in an alternative embodiment, the registration module 8A is configured to register a profile CellPROF for each cell managed by a gNB base station of the network AN, with each profile CellPROF being associated with a cell comprising information representing the current deployment conditions of this cell. In the first embodiment described herein, the profiles gNBPROF of the base stations of the network AN are delivered to the registration module 8A by the base stations themselves; and
a response module 8B, configured to transmit, in response to a discovery request REQ received from a device of the network NW (for example, one of the requesting devices hosting the instances 4, 5 and 6) relating to at least one search criterion CRIT, all or some of the profiles registered by the registration module 8A in the non-volatile memory 13, and which are associated with entities of the network NW meeting the search criterion CRIT indicated in the discovery request. For example, the criterion CRIT relates to at least one cell of the network NW, and the response module 8B is configured to respond to the received discovery request by supplying it with all or some of the one or more profiles CellPROF corresponding to the criterion CRIT.

In the first embodiment described herein of an NRF device 8 as defined by the 3GPP standard, the registration 8A and response 8B modules respectively use the logic of the Nnrf_NFManagement and Nnrf_NFDiscovery services described in the 3GPP documents TS 23.502 entitled, “Technical Specification Group Services and System Aspects; Procedures for the 5G System (5GS); Stage 2; (Release 17)”, V17.4.0, March 2022, and TS 29.510 entitled, “Technical Specification Group Core Network and Terminals; 5G System; Network Function Repository Services; Stage 3; (Release 17)”, V17.5.0, March 2022 (with the exception of the arrangements required for implementing the invention described hereafter).

The operation of the modules 8A and 8B of the NRF device 8 is described in further detail hereafter with reference to the steps of the management method according to the invention.

Moreover, the non-volatile memory 13 of the computer 9 comprises, when it is the base station 3 hosting the entity 7 or it hosts the base station 3, a recording of a computer program PROG2, comprising instructions defining the main steps of a communication method according to the invention.

This program PROG2 defines the functional modules of an entity 7 according to the invention (and of the base station 3 hosting the entity 7, in the first embodiment, or of an access management device in the second embodiment as described in further detail hereafter) that use or control the aforementioned hardware elements 10 to 14 of the computer 9. These modules notably comprise, as illustrated in FIG. 3, a registration module 7A, in this case configured to register the profile gNBPROF(3) of the base station 3 with the NRF device 8. As mentioned above, in an alternative embodiment, the module 7A can be configured to register the profile CellPROF of each cell managed by the base station 3 with the NRF device 8, i.e., the profiles CellPROF(C1) of the cell C1, the profiles CellPROF(C2) of the cell C2 and the profiles CellPROF(C3) of the cell C3, with each profile of a cell comprising information representing the current deployment conditions of this cell.

The operation of the module 7A of the entity 7 hosted by the base station 3 is described in further detail hereafter with reference to the steps of the communication method according to the invention.

Finally, the non-volatile memory 13 of the computer 9 comprises, when it is a requesting device or it hosts such a requesting device, a recording of a computer program PROG3, comprising instructions defining the main steps of a discovery method according to the invention.

This program PROG3 defines the functional modules of a requesting device according to the invention (such as the AMF instances 4, the SMF instances 5 and the NWDAF instances 6 in the first embodiment described herein) that use or control the aforementioned hardware elements 10 to 14 of the computer 9. These modules notably comprise, as illustrated in FIG. 3:
a sending module 16A configured to send a discovery request to the NRF device 8. This discovery request relates to at least one search criterion CRIT, for example, on at least one cell of the network NW managed by a base station of the cellular network;
a receiving module 16B, configured to receive a response to the discovery request. If the search criterion CRIT indicated in the discovery request relates to at least one cell of the network NW, then the response received from the NRF device 8 comprises information representing current deployment conditions of said at least one cell stored in said at least one profile gNBPROF of said at least one base station managing said at least one cell, maintained by the NRF device 8; and
a utilization module 16C, configured to use all or some of said received information, for example, when delivering a functionality implemented by the requesting device in the network NW. For example, if the requesting device is the AMF instance 4, the module 16C can use the deployment condition information delivered by the NRF device 8 to determine the RA of a UE. According to another illustrative example, if the requesting device is the SMF instance 5, the module 16C can use the deployment condition information delivered by the NRF device 8 to determine some parameters of a session with a UE. In yet another example, if the requesting device is the NWDAF instance 6, the module 16C can use the deployment condition information provided by the NRF device 8 to improve its predictions related to a UE.

The operation of the modules 16A to 16C of the requesting device according to the invention is described in further detail hereafter with reference to the steps of the discovery method according to the invention.

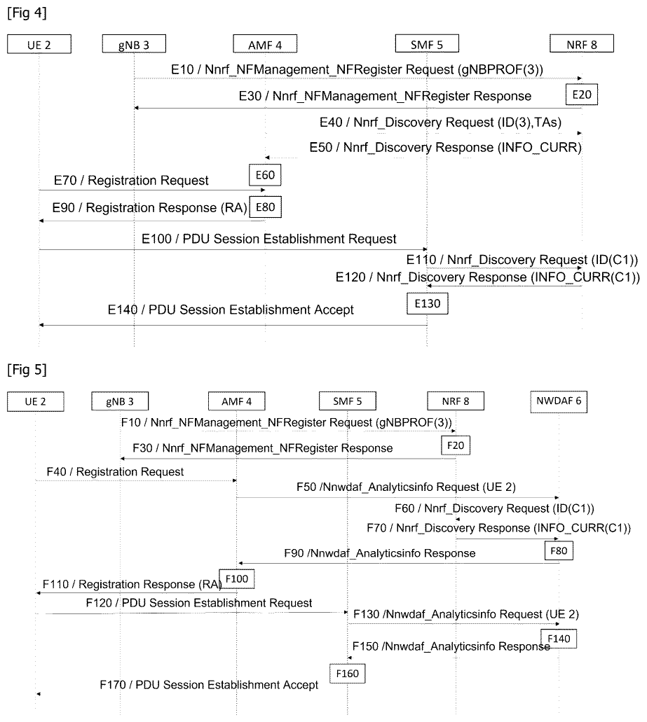

The main steps of the communication, management and discovery methods according to the invention will now be described with reference to FIG. 4, which illustrates a first example of an application of the invention, when they are respectively implemented in the first embodiment of the invention, by the base station 3 hosting the entity 7, by the NRF device 8, and by the AMF and SMF instances, 4 and 5.

It is assumed in this case that, after it is activated by the operator OP of the cellular network NW and when it is switched on, the base station 3 registers its profile gNBPROF(3) with the NRF device 8 (step E10), via its registration module 7A. As mentioned above, according to the invention, the profile gNBPROF(3) contains, for each cell C1, C2, C3 managed by the base station 3, information INFO_CURR representing the current deployment conditions of these cells. This information INFO_CURR reflects the actual deployment of the network NW at a given instant, i.e., the geographical areas and the infrastructures covered by the cells, the topology of the network architecture (for example, adjacency between cells), etc. They are dynamic in the sense that they can evolve over time, depending on the decisions made by the operator OP of the network NW or autonomously by the base stations (for example, reconfiguration of certain base stations, etc.), on the movement of the base stations (notably when they are mobile), on the suppression of some cells (for example, in order to limit the energy consumption of the network), on the appearance of new infrastructures (for example, roads, buildings, etc.), etc.

Thus, for example, the information INFO_CURR can include all or some of the following information:
information relating to the arrangement of the cell in the network architecture, such as the logical or radio neighborhood of the cells (in the form, for example, of the identity of the neighboring cells of said cell);
information relating to the geographical environment of the cell, such as the geographical area covered by the cell (expressed, for example, based on the coordinates (latitude and longitude) of the center of the cell and its radius, or on a polygonal spatial pattern using the same type of coordinates or via a reference to a coverage map, etc.);
information relating to the type of deployment of the cell, such as an indoor/outdoor, direct (LOS) or indirect (NLOS) line-of-sight deployment, in a white, dense, suburban or rural area, having a coverage or capacity function, in support of a private network, of an infrastructure or of a critical vertical, event-driven/temporary deployment, configuration of the deployment (for example, macro/small/pico cell, or cell managed by a base station on board a high-altitude platform, a drone or a satellite, etc.);
information relating to a configuration of at least one antenna of the cell, such as the position and the orientation of this antenna (latitude, longitude, altitude, ground height, azimuth, incline), the deployment of a distributed antenna system (or DAS);
information relating to at least one infrastructure covered by the cell, for example, a main road, a railway track, a waterway, one or more buildings, an industrial zone, etc. (expressed, for example, in the form of the identity of the infrastructure in question);
information relating to the state of the cell, such as the load or the load level (for example, low, medium, high) of the cell, the load or the load level of the cell on each network slice, the number of active users in the cell, the uplink (UL) or downlink (DL) throughput, congestion indicators (for example, radio resource utilization rate, number of queued packets), a fault state or an alarm level, a security state (for example, jamming detection), the detection of attacks of the “Man In The Middle Attack” or “false base station”, “Distributed Denial of Service” (DDoS), botnet compromise type, etc.

Of course, this list is not exhaustive and other information representing the current deployment conditions of the cells can be contained in the profiles. Furthermore, the profiles can contain other information INFO_SUPP, such as static configuration information of the cells, such as, for example:
an identity of the cell;
a frequency band used by the cell;
at least one radio access technology associated with the cell (for example, GERAN, UTRA, E-UTRA, NR);
etc.

It should be noted that some of these items of information that are currently static within the context of 5G networks can be considered to express a more dynamic nature in a subsequent release of these networks or in another context.

The profile gNBPROF(3) of the base station 3 can also contain information INFO_gNB relating to the base station 3, such as its identity (in the form, for example, of a “Global RAN Node ID” identifier), the list of TAs and/or slices that it supports, information representing its state (for example, load or load level, number of users using the base station), etc.

The profile gNBPROF(3) is stored, for example, in the non-volatile memory 13 of the base station 3. It should be noted that the information INFO_CURR, INFO_SUPP and/or INFO_gNB may have been configured on the base station 3 by the network operator OP (via means that are known per se and are not described herein), or may have been dynamically acquired or discovered by the base station 3.

For example, the base station 3 can evaluate some of this information itself, such as the geographical area covered by each of the cells C1, C2 and C3. To this end, it can notably use the geographical location of the UEs that are linked to the cell in question, with this location being able to be fed back by satellite positioning modules (or PNT “Positioning Navigation and Timing Service”), such as GPS or GNSS modules installed on the UEs or being able to be computed by the base station 3 based on the TDOA and speed information it has on the UEs. By virtue of the location of the UEs and the knowledge of the cells serving each of these UEs, the base station 3 can establish a “map” of the UEs and deduce the coverage limits of each cell therefrom.

According to another example, which is particularly well adapted in the case of a mobile base station 3 equipped with a PNT receiver and a compass, the base station 3 can evaluate the position and the orientation of the antennas serving the cells that it manages based on the positions fed back by its PNT receiver and the indications provided by its compass.

According to yet another example, the base station 3 can determine the identity of the neighboring cells of each cell that it manages by using the ANR (“Automatic Neighbor Relation”) functionality of SON (“Self-Organizing Networks”) technology that is designed, in a manner known per se, to allow self-configuration, self-exploitation and self-optimization of the equipment of a cellular communication network.

According to another example, the base station 3 can deduce information relating to the state of the cell from its own state: for example, if the base station 3 encounters an overload problem typically caused by the limitation of its processing capacities, this will have repercussions on the state of the cells it manages, which themselves will be in an overloaded state.

Furthermore, the base station 3 has, in a manner known per se, information concerning the use of the network resources. Based on this information, it can detect a state (or a level) of congestion of the cells that it manages. Such congestion is likely to affect various types of resources used by the cell, such as radio resources or PRBs (“Physical Resource Block”), buffers or even radio channels (for example, traffic, signaling or paging channels), and intervenes when 100% of the resources in question are used (for example, 100% of the buffers are full). In order to detect such a state, various advanced congestion indicators can be monitored such as, for example, a utilization percentage of the resources that approaches a critical threshold, an increase in the delays or losses of packets observed on the cell, etc. These indicators can be considered from the information INFO_CURR.

The base station 3 can also acquire some of the third-party entity information, for example, entities of the network NW or external entities. Notably, it is possible to contemplate that the base station 3 is configured to communicate with the radio scheduling system 15 adapted to the network NW, and to acquire certain information from this radio scheduling system, such as, for example, the information relating to the type of deployment of the cells C1, C2 and C3 that it manages, the identity of the infrastructures covered by each of these cells, or even the information relating to the deployment configuration of these cells.

The base station 3 also may be aware of some of this information because it uses it to implement the processing operations it is responsible for (for example, identity of the neighboring cells, frequency band used by each cell or even access network technology implemented in each cell), or because it is configured to broadcast this information over the network NW (for example, the identity of the cells it manages, list of TAs and/or network slices that it supports).

The nature of the information INFO_CURR, and, if applicable, INFO_SUPP and INFO_gNB, contained in the profile gNBPROF(3) of the base station 3 can be defined on the base station 3 by default (and more specifically on the entity 7), for example, by the operator of the network NW, or by a management platform, also known as OAM “Operations, Administration and Maintenance”) platform.

In order to register the profile gNBPROF of the base station 3 with the NRF device 8, in the first embodiment described herein, the registration module 7A uses the Nnrf_NFManagement_NFRegister service defined in the aforementioned 3GPP documents TS 23.502 and TS 29.510, adapted for the requirements of the invention. More specifically, the request to register the Nnrf_NFManagement_NFRegister service (“Nnrf_NFManagement_NFRegister Request” message), normally used by the NF functions of the core network CN to register their respective NFPROF profiles with the NRF device 8, is adapted to be used by the base station 3 (and more specifically by the registration module 7A of the entity 7 hosted by the base station 3) to register its profile gNBPROF(3). This adaptation involves modifying the request so that it contains the information INFO_CURR in the profile gNBPROF(3), for each cell C1, C2 and C3 managed by the base station 3, and, if applicable, so that it contains the information INFO_SUPP and INFO_gNB. Such an adaptation is obvious to a person skilled in the art and is not described in further detail herein.

Upon reception of the registration request from the base station 3, the NRF device 8 uses its registration module 8A to store the profile gNBPROF(3), for example, in its non-volatile memory 13 (step E20).

It then sends a confirmation message (“Nnrf_NFManagement_NFRegister Response” message), via its registration module 8A, confirming the registration of the profile gNBPROF(3) to the base station 3 using the Nnrf_NFManagement_NFRegister service, in a similar or identical manner to when it registers the profile of an NF function (step E30).

It will now be assumed that when it detects the activation of a new base station (namely, the base station 3 in this case), the AMF instance 4 polls the NRF device 8 in order to acquire information concerning the cells of the network NW managed by this new base station 3 located in its service area (in other words, in the TAs that the AMF instance 4 serves) (step E40). To this end, in the first embodiment described herein, the sending module 16A of the AMF instance 4 uses the Nnrf_NFManagement_NFDiscovery service defined in the aforementioned 3GPP documents TS 23.502 and TS 29.510, adapted for the requirements of the invention. More specifically, the sending module 16A of the AMF instance 4 sends a discovery request (“Nnrf_NFManagement_NFDiscovery Request” message) to the NRF device 8, as defined by the Nnrf_NFManagement_NFDiscovery service indicating the identity of the newly detected base station 3 and the TA served by the AMF instance 4 as search criteria.

It should be noted that, as a variant, this polling of the NRF device 8 by the AMF instance 4 can occur at times other than in response to the activation of the base station 3. Thus, for example, this polling can be initiated when the AMF instance 4 detects that it needs information concerning a UE that it manages.

Upon reception of the discovery request from the AMF instance 4, the NRF device 8 consults the profiles stored in its non-volatile memory 13, selects the candidate base stations matching the search criteria indicated in the discovery request (the base station 3 in the example contemplated in this case), and responds to the AMF instance 4 via its response module 8B using the Nnrf_NFManagement_NFDiscovery service (step E50). According to the invention, the response (“Nnrf_NFManagement_NFDiscovery Response” message) sent by the response module 8B includes all or some of the profile gNBPROF(3) of the base station 3. In particular, for each cell managed by the base station 3, the response sent by the response module 8B includes all or some of the information INFO_CURR, and, if applicable, all or some of the information INFO_SUPP and INFO_gNB associated with this cell and contained in the profile gNBPROF(3). It should be noted that sending only a portion of the profile gNBPROF(3) of the base station 3 can be due to the limitations specified in the search criteria CRIT indicated in the discovery request, but also due to a configuration of the NRF device 8 (for example, the NRF device 8 can be configured to deliver such types of information to such a type of application entity).

Upon reception of this response by its receiving module 16B, the AMF instance 4 extracts the information contained in the response and stores it, for example, in its non-volatile memory 13. The AMF instance 4 deduces, from the information that it has received concerning the cells managed by the base station 3 forming part of the TAs that it serves, indications concerning these TAs (for example, their topology, the adjacency relations between these TAs, the type of deployment applied in these TAs, etc.) (step E60).

It should be noted that other factors can initiate the AMF instance 4 sending a discovery request to the NRF device 8. For example, such a discovery request can be sent when the operator OP of the network NW (and of the core network CN) initiates the AMF instance 4, in which case the discovery request can relate to the cells covered by several base stations of the network NW if this proves to be relevant (typically, if several base stations serve the service area of the AMF instance 4 or are discovered by the AMF instance when it is initiated).

It will now be assumed that the UE 2 registers with the core network CN via the base station 3 (step E70). In a manner known per se, the registration request of the UE 2 (“Registration Request”) is transmitted to an AMF instance, for example, in this case to the AMF instance 4. If the registration request of the UE 2 is accepted, the AMF instance 4 then determines its registration area RA (step E80). During this determination process (functionality implemented by the AMF instance 4 within the meaning of the invention), the utilization module 16C of the AMF instance 4 can advantageously use, by virtue of the invention, the indications acquired during step E60, which allows it to form an RA adapted to the context in which the UE 2 finds itself. For example, the utilization module 16C can include, in the RA of the UE 2, TAs adjacent to the TA of the cell used by the UE 2 for registration (cell C1 in the example illustrated in FIG. 1), or TAs that cover the same infrastructure (for example, the same railway). Of course, this example is provided solely by way of an illustration and is not limiting per se.

It should be noted that steps E40 to E60 can be implemented as described before or after step E70.

The other steps of the registration procedure for the UE 2 are identical or similar to the steps described in document 3GPP TS 23.502, paragraph 4.2.2.2.2, and are not described in further detail herein.

The AMF instance 4 sends the registration confirmation (“Registration Accept”) to the UE 2, with this confirmation including the RA that it has just determined (step E90).

Following its registration, the UE 2 needs to establish a session (“PDU Session Establishment Request”) (step E100). The AMF instance 4 through which the request passes can determine, in a manner known per se, the SMF instance that will manage this session (the SMF instance 5 in the example contemplated in this case), or using the information received during step E60 concerning the cell C1 to which the UE 2 is linked in order to identify this instance (depicted in a single step E100 in FIG. 4). For example, it is possible to contemplate determining by learning correlations between the type of deployment of the cells and the features of the session (for example, duration, throughput), and selecting, taking into account these correlations, the most suitable SMF instance for managing the session requested by the UE 2.

Upon reception of the session establishment request, the SMF instance 5, via its sending module 16A, in this case in turn polls the NRF device 8 in order to acquire information concerning the cell C1 to which the UE 2 is linked (step E110). To this end, as described above for the AMF instance 4, the sending module 16A of the SMF instance 5 uses the Nnrf_NFManagement_NFDiscovery service defined in documents 3GPP TS 23.502 and TS 29.510 adapted for the requirements of the invention. More specifically, the sending module 16A of the SMF instance 5 sends the NRF device 8A a discovery request (“Nnrf_NFManagement_NFDiscovery Request” message), as defined by the Nnrf_NFManagement_NFDiscovery service, indicating the identity of the cell C1 used by the UE 2 to access the network as the search criterion.

Upon reception of the discovery request from the SMF instance 5, the NRF device 8 consults the profiles stored in its non-volatile memory 13, identifies the profile gNBPROF(3) of the base station 3 managing the cell C1 indicated in the discovery request, and responds to the SMF instance 5 via its response module 8B using the Nnrf_NFManagement_NFDiscovery service (step E120). According to the invention, the response (“Nnrf_NFManagement_NFDiscovery Response” message) sent by the response module 8B includes all or some of the information contained in the profile gNBPROF(3) associated with the cell C1, and in particular, all or some of the information INFO_CURR relating to this cell.

The response is received by the receiving module 16B of the SMF instance 5, then the utilization module 16C of the SMF instance 5 uses the received information concerning the cell C1 to establish the session requested by the UE 2 (functionality implemented by the SMF instance 5 within the meaning of the invention) (step E130). More specifically in this case, the utilization module 16C of the SMF instance 5 uses this information to optimally determine some parameters of the session, for example, the one or more network functions of the user plane, or UPF (“User Plane Function”), that will route the data. This can be implemented, as described above, by using correlations established between the types of deployment of the cells and the features of sessions, notably such as the throughput. Of course, this example is provided solely by way of an illustration and is not limiting per se.

The other steps of the procedure for establishing the session of the UE 2 are identical or similar to the steps described in document 3GPP TS 23.502, paragraph 4.3.2.2.1, and are not described in further detail herein.

The SMF instance 5 then confirms the establishment of the session with the UE 2 (“PDU Session Establishment Accept”) (step E140).

In the above, the AMF and SMF devices, 4 and 5, in turn each polled the NRF device 8 in order to acquire current deployment condition information of the cells of the network NW and used this information in order to implement the functionalities attributed to them in steps E80, E100 and E130. Of course, these assumptions are not limiting per se, and it is possible to contemplate that such information is requested and used only for a limited number of these steps (typically only one or two of these steps).

In the first embodiment described herein, the Nnrf_NFManagement_NFRegister and Nnrf_NFManagement_NFDiscovery services defined by the 3GPP standard for the exchanges between the NF functions and the NRF function of the core network have been preferably used and adapted to manage the exchanges between the base station 3 and the NRF function 8 (registration of the profile of the base station or of the cells), on the one hand, and between the NRF function 8 and the NF consumer functions 4, 5 (discovery of the information contained in the profile of the base station or of the cells), on the other hand. In another embodiment, it is possible to contemplate proceeding in a different manner, notably using messages dedicated to the invention that allow the base station 3 to register its profile (or the profile of the cells that it manages) with the NRF device 8 and that allow the NF functions of the core network to access the information concerning the cells that is stored in this profile (or these profiles).

Furthermore, it is possible to contemplate registering the profiles of the base stations of the network NW containing the information concerning the current deployment conditions of the cells with an entity of the network NW (control device within the meaning of the invention) other than the NRF device 8, for example, an entity responsible for managing application entities of the access network AN (notably including the base stations of the access network AN), and to contemplate maintaining profiles for these application entities, with said other entity being able to be accessible via an API or any other type of interface.

Moreover, in the first embodiment described herein, if the base station 3 detects an evolution in the information representing the current deployment conditions of one or more cells that it manages, it uses its registration module 7A to update its profile gNBPROF(3) with the NRF device 8 using the Nnrf_NFManagement_NFRegister service defined by the 3GPP standard in documents TS 23.501 and TS 29.510, adapted for the requirements of the invention to include the information representing the updated current deployment conditions. Following this update of the profile gNBPROF(3), in the same way as for the information contained in the profiles of the NF functions stored by the NRF device 8, the NRF device 8 notifies the “consumer” NF functions that subscribed to the update notifications of the profile of the base station 3 or information relating to one or more cells managed by the base station 3, and provides them with the information representing the current deployment conditions of the cells that have evolved corresponding to their subscription. The same procedure is applied when cell profiles are registered with the NRF device 8.

FIG. 5 illustrates a second example of an application of the invention according to the first embodiment, in which the steps of the communication method are implemented by the base station 3 hosting the entity 7, the steps of the management method are implemented by the NRF device 8, and the steps of the discovery method are implemented by the NWDAF instance 6.

Following its activation by the operator OP of the cellular network NW and when it is switched on, the base station 3 registers its profile gNBPROF(3) with the NRF device 8, via its registration module 7A, using the Nnrf_NFManagement_NFRegister service adapted for the requirements of the invention (“Nnrf_NFManagement_NFRegister Request message) (step F10). It should be noted that this type of registration can also occur following the modification of all or some of the information contained in the profile gNBPROF(3).

Upon reception of the registration request from the base station 3, the NRF device 8 uses its registration module 8A to store the profile gNBPROF(3), for example, in its non-volatile memory 13 (step F20).

Then it uses its registration module 8A to send a confirmation message (“Nnrf_NFManagement_NFRegister Response” message) confirming the registration of the profile gNBPROF(3) to the base station 3 using the Nnrf_NFManagement_NFRegister service, in a similar or identical manner to when it registered the profile of an NF function (step F30).

It will now be assumed that the UE 2 registers with the core network CN via the base station 3 (step F40). In a manner known per se, the registration request of the UE 2 (“Registration Request”) is transmitted to the AMF instance 4 linked to this UE.

Steps F10, F20, F30 and F40 are respectively identical to steps E10, E20, E30 and E70 described above with reference to FIG. 4, and are not reviewed in detail herein.

In the second embodiment described herein, it is assumed that, upon reception of the registration request of the UE 2, the AMF instance 4 asks the NWDAF instance 6 for predictions/statistics and more specifically predictions concerning the mobility of the UE 2 (“Nnwdaf_AnalyticsInfo Request” message) (step F50). To this end, it uses, in the first embodiment described herein, the Nnwdaf_AnalyticsInfo service described in the 3GPP documents TS 23.288 entitled, “Architecture Enhancements for 5G system (5GS) to support network data analytics services (Release 17)”, V17.4.0, March 2022, and TS 28.520 entitled, “Technical Specification Group Core Network and Terminals; 5G System; Network Data Analytics Services; Stage 3; (Release 17)”, V17.6.0, March 2022. It should be noted that this request can be in the form of a simple request “Nnwdaf_AnalyticsInfo Request”, as described herein, or as a variant can be in the form of a subscription using the Nnwdaf_Analytics Subscription service as described in the aforementioned documents TS 23.288 and TS 29.520.

Upon reception of the request for predictions from the AMF instance 4, the NWDAF instance 6 collects the data INPUT_DATA required for computing the requested predictions, as described in document TS 23.288, paragraph 6.7.2.4. Furthermore, the NWDAF instance 6 uses its sending module 16A to poll the NRF device 8 in order to acquire information concerning the cell of the network NW used by the UE 2. The cell identifier used by the UE 2 (C1 in the example contemplated in this case) can be acquired by the NWDAF instance 6, for example, based on the data INPUT_DATA that it has collected.

In order to poll the NRF device 8, the sending module 16A of the NWDAF instance 6 sends a discovery request (“Nnrf_NFManagement_NFDiscovery Request” message) to the NRF device 8 (step F60), in a similar or identical manner to that previously described in step E110 for the SMF instance 5 with reference to FIG. 4. More specifically, the discovery request as defined by the Nnrf_NFManagement_NFDiscovery service in this case indicates the identity of the cell C1 used by the UE 2 to access the network as a search criterion.

Upon reception of the discovery request of the NWDAF instance 6, the NRF device 8 consults the profiles registered in its non-volatile memory 13, identifies the profile gNBPROF(3) of the base station 3 managing the cell C1 indicated in the discovery request, and responds to the NWDAF instance 6 via its response module 8B using the Nnrf_NFManagement_NFDiscovery service (step F70). According to the invention, the response (“Nnrf_NFManagement_NFDiscovery Response” message) sent by the response module 8B includes all or some of the information contained in the profile gNBPROF(3) associated with the cell C1, and, in particular, all or some of the information INFO_CUR relating to this cell.

The response from the NRF device 8 is received by the receiving module 16B of the NWDAF instance 6. The NWDAF instance 6 uses its utilization module 16C to establish the predictions requested by the AMF instance 4 (functionality implemented by the NWDAF instance 6 within the meaning of the invention), by using, on the one hand, the collected data INPUT_DATA, but also in this case all or some of the information received from the NRF device 8 concerning the cell C1, and in particular all or some of the information INFO_CURR concerning current deployment conditions of the cell C1 received from the NRF device 8 (step F80). For example, the predictions of the NWDAF instance 6 can be influenced by the type of deployment of the cell C1 and notably the fact that it is deployed to support a given infrastructure such as a highway: the future positions of the UE 2 located on this highway will then have a greater probability. Of course, this example is provided solely by way of an illustration and is not limiting per se.

It should be noted that steps F60 to F80 described above can be reiterated and/or executed at other times. For example, the NWDAF instance 6 can observe the movement of the UE 2 for a certain period and poll the NRF device 8 for each of the cells visited by the UE 2 in order to acquire more reliable predictions. This is notably possible when the requesting device for requesting predictions/statistics from the NWDAF instance 6 does not need an immediate response from said instance.

The utilization module 16C of the NWDAF instance 6 transmits the predictions thus established to the AMF instance 4 (“Nnwdaf_AnalyticsInfo Response” message) (step F90), which uses them to establish the RA of the UE 2 in a manner known to a person skilled in the art and not described in detail herein (step F100). For example, the RA can contain all the TAs containing the future positions of the UE 2 predicted by the NWDAF instance 6. Of course, this example is provided solely by way of an illustration and is not limiting per se.

The other steps of the registration procedure for the UE 2 are identical or similar to the steps described in 3GPP document TS 23.502, paragraph 4.2.2.2.2, and are not described in further detail herein.

The AMF instance 4 sends the confirmation of the registration to the UE 2 (“Registration Accept”), with this confirmation including the RA that it has just determined (step F110).

Following its registration, the UE 2 requests the establishment of a session (“PDU Session Establishment Request”) (step F120). The AMF instance 4 that the request passes through can conventionally select the SMF instance 5 that will manage this session, as prescribed by the 3GPP standard, optionally using the predictions received during step F90 to select the SMF instance 5.

Upon reception of the session establishment request, the SMF instance 5 asks the NWDAF instance 6 for the predictions/statistics concerning the UE 2, such as, for example, predictions concerning the communications of the UE 2 (“Nnwdaf_Analytics Info Request” message) (step F130). As described above for the AMF instance 4 in step F50, the SMF instance 5 to this end uses, in the first embodiment described herein, the Nnwdaf_Analytics Info service described in 3GPP documents TS 23.288 and TS 28.520. Steps F60 and F70 can be reiterated by the NWDAF instance 6 (not shown in FIG. 5) if necessary. This notably can be the case when the NWDAF instance 6 is asked to under-take various types of predictions/statistics, such as, for example, in this case, by the AMF instance 4 to establish predictions concerning the mobility of the UE 2 and by the SMF instance 5 to establish predictions concerning the communications of the UE 2, the discovery requests addressed to the NRF device 8 can then relate to different search criteria.

The NWDAF instance 6 then uses its utilization module 16C to establish the predictions requested by the SMF instance 5 (functionality implemented by the NWDAF instance 6 within the meaning of the invention) using, not only the data INPUT_DATA that it has collected, but also all or some of the information provided by the NRF device 8 concerning the cell C1 used by the UE 2 to access the network, and in particular all or some of the information INFO_CURR concerning current deployment conditions of the cell C1 (step F140).

The utilization module 16C of the NWDAF instance 6 transmits the predictions thus established to the SMF instance 5 (“Nnwdaf_AnalyticsInfo Response” message) (step F150), which uses them to establish the session requested by the UE 2 (step F160). For example, the utilization module 16C of the SMF instance 5 uses these predictions to optimally determine some parameters of the session, such as the one or more network functions of the user plane, or UPF (“User Plane Function”), that will route the data. For example, depending on the throughputs of the communications of the UE 2 predicted by the NWDAF instance 6, the SMF instance 5 can select an optimized UPF function to process a high throughput or, on the contrary, to process sporadic communications. Of course, this example is provided solely by way of an illustration and is not limiting per se.

The SMF instance 5 then confirms the establishment of the session with the UE 2 (“PDU Session Establishment Accept”) (step F170).

It should be noted that the aforementioned comments concerning the possibility of using messages other than those defined by the Nnrf_NFManagement_NFRegister and Nnrf_NFManagement_NFDiscovery services of the 3GPP standard to update some information concerning the profile of the base station 3 or the cells of the network NW, to poll and use the current deployment condition information of the cells only during certain steps, and to contemplate a control device other than the NRF device 8 (for example, a control device managing application entities of the access network AN such as the base stations) also apply within the context of this second illustrative example.

Moreover, the two illustrative examples described above are not limiting per se, and the invention can be applied in other contexts, and involving other application entities of the core network CN (for example, other network functions) and/or of the access network AN (for example, other base stations). Notably, it is possible to contemplate a base station of the network AN as another requesting device that uses the current deployment condition information of the cells of the network NW to decide upon a transfer or “handover” between two cells for a UE linked to this base station, and to determine the conditions for this handover (notably the target cell). For example, if a UE is determined to be traveling on a railway (for example, by means of the predictions made by an NWDAF network function), the base station could, by virtue of the information INFO_CURR acquired from the NRF device 8, select only those candidate neighboring cells from among the candidate neighboring cells (which are configured on the base station) that cover the railway in question that the UE is traveling on as potential targets for the handover of the UE. It should be noted that the APIs that are currently defined by the 3GPP standard do not allow a gNB base station to poll an NRF device; consequently, it would be worthwhile adapting this API (which would not be difficult for a person skilled in the art) or providing an interface allowing the base station to poll the NRF device in order to acquire the information INFO_CURR of interest.

In the first embodiment described above, the base station 3 hosts the entity 7, and itself registers its profile gNBPROF(3), or the profile CellPROF of the cells C1, C2 and C3 that it manages, with the NRF device 8. The description provided with reference to the base station 3 is implemented by all or some of the base stations of the network NW.

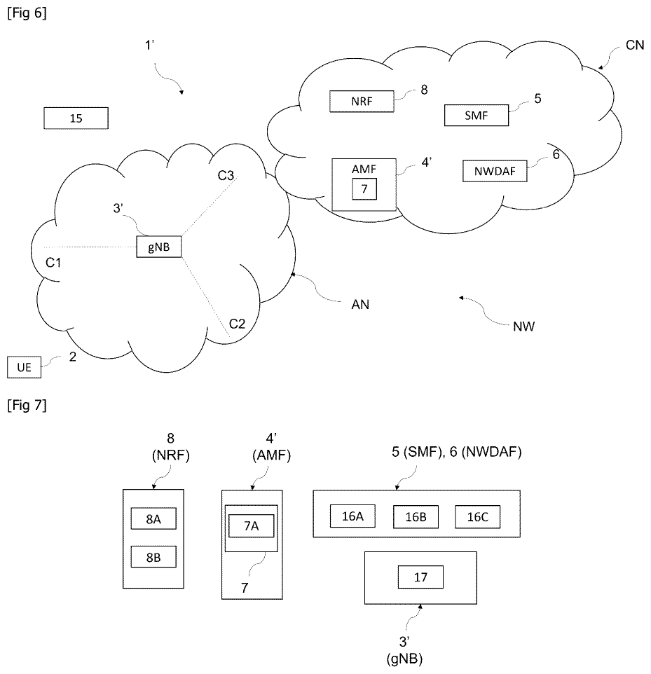

A second embodiment of the invention will now be considered with reference to FIG. 6, in which the entity 7 is hosted in an application entity of the core network CN, and more specifically in a device hosting a network function, namely, an AMF instance (network access management device within the meaning of the invention). The same references as those used in FIGS. 1 to 3 are used for the elements that are identical to the first embodiment and for which the features described in the first embodiment apply in the second embodiment.

Thus, FIG. 6 shows a system 1′ in a cellular communication network NW according to the second embodiment of the invention. The network NW is as described above with reference to the first embodiment, namely, a 5G network as defined by the 3GPP standard, managed by an operator OP, and comprising at least one access network AN and a core network CN.

In order to access the services offered by the network NW, the UE 2 connects to the core network CN by means of the access network AN, and more specifically a gNB base station 3′ of this access network. The gNB base station 3′ is configured to manage one or more cells of the network NW; in the example contemplated in this case, the base station 3′ is a tri-sectorial gNB managing three cells of the network C1, C2 and C3.

The core network CN uses several network functions as described above for the first embodiment, and notably uses AMF network function instances 4′, SMF network function instances 5 and NWDAF network function instances 6.

According to the invention, the system 1′ comprises:
at least one gNB base station managing at least one cell of the network NW, according to the invention, namely, the base station 3′ managing the cells C1, C2 and C3 of the network NW;
at least one requesting device, according to the invention, namely, in the example illustrated in FIG. 6, the NWDAF instance 6. Of course, this example is provided solely by way of an illustration, and other entities of the network NW, in particular other network functions or network function instances of the core network CN can be requesting devices within the meaning of the invention;
at least one entity 7 of the network NW according to the invention. In the second embodiment, the entity 7 is hosted by the AMF instance 4′ (access management device within the meaning of the invention); and
a control device 8 of the network NW, according to the invention, as described in the first embodiment of the invention.

FIG. 7 shows the distribution of the functional modules 8A-8B, 7A, and 16A to 165C respectively defined by the programs PROG1, PROG2 and PROG3, throughout the various elements of the system 1′, previously described for the first embodiment. The features of these modules remain the same for the second embodiment except that the entity 7 (and therefore the registration module 7A) is now hosted in a network function instance of the core network CN, namely, in the AMF instance 4′. It should be noted that the AMF instance 4′ also can be a requesting device within the meaning of the invention in the second embodiment and can host modules 16A-16C (however, these are not shown in FIG. 7).

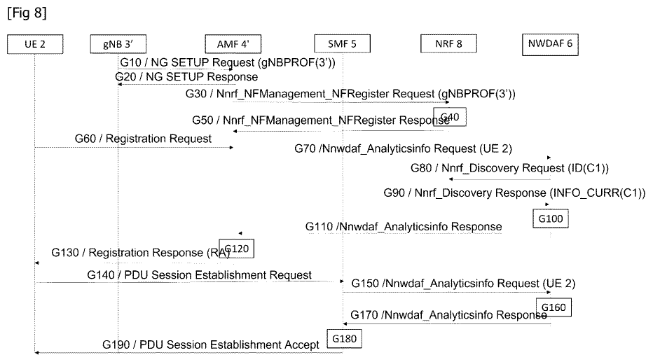

The main steps of the communication, management and discovery methods respectively implemented by the AMF instance 4′ hosting the entity 7, by the NRF device 8, and by the NWDAF instance 6 will now be described with reference to FIG. 8, which illustrates an example of an application of the invention in the second embodiment. It should be noted that the second embodiment is particularly well adapted when the base station 3′ does not support the one or more protocols allowing the services of the AMF instance 4′ or of the NRF device 8 to be used (notably the HTTP2 protocol in the example of a 5G network defined by the 3GPP standard).

Following its activation by the operator OP of the cellular network NW, the base station 3′ initiates an association procedure with the AMF instance 4′ designated to manage the base station 3′ (step G10). To this end, in the second embodiment described herein, the base station 3′ executes the “NG Setup” procedure described in the 3GPP document TS 38.413 entitled, “Technical Specification Group Radio Access Network; NG-RAN; NG Application Protocol (NGAP); (Release 17)”, V17.0.0, April 2022, paragraph 8.7.1. However, according to the invention, during this procedure, the base station 3′ enriches the association message (“NG SETUP Request” message) sent to the AMF instance 4′ with its profile gNBPROF(3′). As described in the first embodiment of the invention, the profile gNBPROF(3′) contains, for each cell C1, C2, C3 managed by the base station 3′, information INFO_CURR representing the current deployment conditions of these cells, and optionally additional information INFO_SUPP and INFO_gNB relating to the base station 3′. The information INFO_CURR, INFO_SUPP and INFO_gNB considered in the second embodiment is identical to that considered in the first embodiment and is not described in detail again in this case. The same applies to how the base station 3′ acquires this information (operator configuration, evaluation thereby, or acquisition from third-party entities such as a radio scheduling system adapted to the network NW).

Furthermore, as in the first embodiment, it is possible to contemplate that instead of transmitting its profile gNBPROF(3′) to the AMF instance 4′, the base station 3′ transmits a profile CellPROF for each of the cells C1, C2 and C3 that it manages.

The AMF instance 4′ extracts the profile gNBPROF(3′) transmitted by the base station 3′ and stores it, for example, in its non-volatile memory 13. It finalizes the association procedure with the base station 3′ as described in document 38.413 (step G20 and “NG SETUP Response” message).

Following the reception of the profile gNBPROF(3′) of the base station 3′, the AMF instance 4′ uses its registration module 7A to register the profile gNBPROF(3′) with the NRF device 8 (step G30).

To this end, in the second embodiment described herein, the registration module 7A of the AMF instance 4′ uses the Nnrf_NFManagement_NFRegister service defined in the aforementioned 3GPP documents TS 23.502 and TS 29.510, adapted for the requirements of the invention. More specifically, the request to register the Nnrf_NFManagement_NFRegister service (“Nnrf_NFManagement_NFRegister Request” message), usually used by the NF functions of the core network CN to register their respective NFPROF profiles with the NRF device 8, is adapted to be used by the AMF instance 4′ (and more specifically by the registration module 7A of the entity 7 hosted by the AMF instance 4′) to register the profile gNBPROF(3′) of the base station 3′. The request “Nnrf_NFManagement_NFRegister Request” is therefore modified, even though it is sent by the AMF instance 4′, to contain the profile gNBPROF(3′) of the base station 3′ that comprises, for each cell C1, C2 and C3 managed by the base station 3′, the information INFO_CURR, and, if applicable, the information INFO_SUPP and INFO_gNB. Such an adaptation would not be an issue for a person skilled in the art and is not described in further detail herein.

Upon reception of the registration request from the AMF instance 4′, the NRF device 8 uses its registration module 8A to store the profile gNBPROF(3′), for example, in its non-volatile memory 13 (step G40). Thus, on completion of this step, the non-volatile memory 13 of the NRF device 8 has not only the profiles of the NF functions of the core network CN, but also the profile of the base station 3′ (as well as other base stations of the network NW, with the profiles of these other base stations having been registered by the AMF instance 4′ if they are linked to this instance or by other AMF instances of the core network that have proceeded in a similar or identical manner).

The NRF device 8 then uses its registration module 8A to send a confirmation message (“Nnrf_NFManagement_NFRegister Response” message) confirming the registration of the profile gNBPROF(3′) of the base station 3′ to the AMF instance 4′, by using the Nnrf_NFManagement _NFRegister service, in a similar or identical manner to that undertaken when registering the profile of an NF function (step G50).

It will now be assumed that the UE 2 registers with the core network CN by means of the base station 3′, and more specifically with the AMF instance 4′ (step G60). Step G60, then the following series of steps G70 to G190, are respectively identical to steps F40 and then F50 to F170 described with reference to FIG. 5 and are not described again in this case.

It should be noted that the aforementioned comments concerning the possibility of using messages other than those defined by the Nnrf_NFManagement_NFRegister and Nnrf_NFManagement_NFDiscovery services of the 3GPP standard or of updating certain information concerning the profile of the base station 3 or of the cells of the network NW also apply within the context of this second embodiment. Moreover, the illustrative example described above is not limiting per se, and the invention can be applied in other contexts, and involving other application entities of the core network CN (for example, other network functions). Furthermore, the above description with reference to the profile gNBPROF(3′) of the base station can be applied to the profile CellPROF of each cell managed by the base station 3′.

In the two embodiments that have been described, the network NW is a 5G network as defined by the 3GPP standard. However, as mentioned above, the invention is not limited to this context and can be applied to other networks, for example, to a 6G network or to a proprietary network.

1. A method for communicating with a control device of a cellular communication network, configured to manage application entities of the network offering services in the network and to maintain a profile of these application entities, the method comprising registering a profile with the control device, with this profile comprising information representing current deployment conditions of at least one network cell managed by a base station of the network.

2. The method of claim 1, wherein said profile is a profile of the base station or a profile of said at least one network cell.

3. The method of claim 1, wherein the method is implemented by said base station, the method further comprising evaluating at least a portion of said information before registering it with the control device.

4. The method of claim 1, wherein the method is implemented by said base station, the method further comprising acquiring, from a network-adapted radio planning system, at least a portion of said information before registering it with the control device.

5. The method of claim 1, wherein the method is implemented by an access management device of the cellular network, the method further comprising acquiring at least a portion of said information from the base station when associating said base station with said access management device.

6. A method for managing a cellular communication network using a control device, configured to manage application entities of the network offering services in the network and to maintain a profile of these application entities, said method comprising:
registering a profile provided by an entity of the cellular network and comprising information representing current deployment conditions of at least one cell of the cellular network managed by a base station of the network; and
in response to a discovery request received from a receiving device of the network, transmitting all or some of said profile to said requesting device.

7. The method of claim 6, wherein said profile is delivered to the control device by said base station or by an access management device of the cellular network.

8. The method of claim 6, further comprising:
updating at least one item of said information in said profile; and
notifying said requesting device of said at least one updated item of information.

9. The method of claim 1, wherein at least one of said items of information representing current deployment conditions relates to an arrangement of the cell in a network architecture, to a geographical environment of the cell, to a configuration of at least one antenna of the cell, to a type of deployment of the cell, to at least one infrastructure covered by the cell, and/or to a state of the cell.

10. The method of claim 1, wherein said profile further comprises:
an identity of the cell; and/or
a frequency band allocated to the cell; and/or
at least one radio access technology associated with the cell.

11. A discovery method using a device, called requesting device, of a cellular communication network, said method comprising:
sending a discovery request to a network control device configured to manage application entities of the network offering services in the network and to maintain a profile of these application entities, with said discovery request relating to at least one cell managed by a base station of the cellular network;
receiving a response to said discovery request comprising information representing current deployment conditions of said at least one cell stored in a profile maintained by the control device; and
using all or some of said received information when delivering a functionality implemented by the requesting device in the network.

12. An entity of a cellular communication network comprising a registration module configured to register a profile with a network control device managing application entities of the network offering services in the network and maintaining a profile of these application entities, with said profile registered by the registration module comprising information representing current deployment conditions of at least one network cell managed by a base station of the network.

13. A base station of a cellular communication network hosting the entity of claim 12, said information relating to at least one network cell managed by said base station.

14. An access management device of a cellular communication network hosting the entity of claim 12.

15. A control device of a cellular communication network configured to manage application entities of the network offering services in the network and to maintain a profile of these application entities, said control device comprising:
a registration module, configured to register a profile delivered by an entity of the cellular network, said profile comprising information representing current deployment conditions of at least one cell of the cellular network managed by a base station of the network; and
a response module, configured to transmit, in response to a discovery request received from a requesting device of the network, all or some of said profile to said requesting device.

16. A requesting device of a cellular communication network, the requesting device comprising:
a sending module configured to send a discovery request to a network control device managing network application entities offering services in the network and maintaining a profile of these application entities, said discovery request relating to at least one cell managed by a base station of the cellular network;
a receiving module, configured to receive a response to said discovery request comprising information representing current deployment conditions of said at least one cell stored in a profile maintained by the control device; and
a utilization module, configured to use all or some of said received information when delivering a functionality implemented by the requesting device in the network.

17. A system in a cellular communication network, the system comprising:
a base station managing at least one network cell;
an entity of the network as claimed in claim 12;
a control device configured to manage application entities of the network offering services in the network and to maintain a profile of these application entities; and
a requesting device;
the control device comprising:
a registration module, configured to register the profile comprising information representing current deployment conditions of the at least one cell of the cellular network managed by the base station of the network; and
a response module, configured to transmit, in response to a discovery request received from a requesting device of the network, all or some of said profile to said requesting device; and
the requesting device comprising:
a sending module configured to send the discovery request to the control device, said discovery request relating to the at least one cell managed by the base station of the cellular network;
a receiving module, configured to receive a response to said discovery request comprising the information representing current deployment conditions of said at least one cell stored in the profile maintained by the control device; and
a utilization module, configured to use all or some of said received information when delivering a functionality implemented by the requesting device in the network.

18. The method of claim 6, wherein at least one of said items of information representing current deployment conditions relates to an arrangement of the cell in a network architecture, to a geographical environment of the cell, to a configuration of at least one antenna of the cell, to a type of deployment of the cell, to at least one infrastructure covered by the cell, and/or to a state of the cell.

19. The method of claim 6, wherein said profile further comprises:
an identity of the cell; and/or
a frequency band allocated to the cell; and/or
at least one radio access technology associated with the cell.
